(19) United States
(12) Patent Application Publication
(10) Pub. No.: US 2016/0116124 A1
(43) Pub. Date: Apr. 28, 2016

(54) LIGHT EMITTING DIODE DEVICE CONFIGURED TO CHANGE COLOR DURING DIMMING

(71) Applicant: SORAA, INC., FREMONT, CA (US)

(72) Inventors: STEPHEN PODOWITZ, FREMONT, CA (US); ROHIT MODI, FREMONT, CA (US); TROY TROTTIER, FREMONT, CA (US); AURELIEN J.F. DAVID, FREMONT, CA (US); MICHAEL RAGAN KRAMES, FREMONT, CA (US)

(21) Appl. No.: 14/925,885

(22) Filed: Oct. 28, 2015

Related U.S. Application Data
(60) Provisional application No. 62/069,528, filed on Oct. 28, 2014.

(51) Int. Cl. F21K 99/00; H05B 33/08; F21V 9/10

(52) U.S. Cl. CPC F21K 9/58; F21V 9/10; H05B 33/0857; F21K 9/56

(57) ABSTRACT

Techniques for emulating dimming curves using temperature-sensitive wavelength-converting materials together with apparatus and method embodiments thereto are disclosed.

### REFERENCE TO RELATED APPLICATION

This application claims the benefit of U.S. Provisional Application No. 62/069,528, filed Oct. 28, 2014, incorporated herein by reference in its entirety.

### FIELD OF DISCLOSURE

The disclosure relates to the field of LED-based illumination products and more particularly to light emitting diodes devices configured to change color along blackbody curves during dimming.

### BACKGROUND

Users desire an LED source that mimics the color changing effect caused by dimming of a filament (such as tungsten or halogen). The effect can be described as a lowering of Correlated Color Temperature (CCT) along the blackbody curve from a nominal 2700-3000K at full power to 2000-2200K at 10% dimming. There have been different attempts at lowering of CCT along the blackbody curve in LED sources. Some attempts use multiple color points to achieve a target color mix at a given power level. For example, using a high CCT LED and low CCT LED driven at differing currents to change intensity balance and final mixed color point have been implemented. Other attempts involve three or more monocolor LEDs (e.g., red, orange, green, blue, etc.) with multiple drivers to model an emanated spectra.

Such attempts are generally costly and require active electrical components in order to obtain desired effects. Therefore, there is a need for a dimming LED source that lowers CCT along the blackbody curve without excessive cost or complexity. The present invention fulfills this need among others.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

One aspect of the invention is a lighting system having a phosphor having a varying conversion efficiency. In one embodiment, the lighting system comprises: (a) at least one light emitting diode (LED) light source, the light source being configured to receive variable power; (b) a first phosphor for converting light; and (c) a second phosphor for converting light, the second phosphor having a conversion efficiency which varies as the power varies; (d) wherein light from the LED, the first phosphor and the second phosphor combine to form emitted light.

Another aspect of the invention is method of varying the conversion efficiency of a phosphor to change the color of light emitted from the lighting system described above. In one embodiment, the method comprises: (a) varying the electrical power to the LED light source causing at least one of flux of the LED light source to vary or the temperature of the lighting system to vary; and (b) whereon the emitted light varies in color as the conversion efficiency varies based on at least one of the flux varying or the temperature varying.

This approach eliminates the additional complication of multiple driver sources. Tuning of the behavior to attain specific shifts/colors can be done by adjusting phosphor temperature- and/or photosensitivities. The foregoing approach can be used to calibrate a specific color in a fixed lamp application by targeting the desired color (e.g., using a one-time driver power calibration adjustment).

In one embodiment, the lighting system is ‘passive’ in that it does not require multiple channel drivers to modulate the spectrum. Therefore, such an embodiment may be integrated to a retrofit lamp or more generally a lighting system in absence of any advanced control circuits. In some such cases, standard-dimming switches provides the needed control.

### BRIEF DESCRIPTION OF DRAWINGS

Those skilled in the art will understand that the drawings, described herein, are for illustration purposes only. The drawings are not intended to limit the scope of the present disclosure.

FIG. 1A depicts an expected color shift to be achieved by emulating dimming curves using temperature-sensitive wavelength-converting materials, according to some embodiments.

FIG. 1B shows a shift in correlated color temperature (CCT) versus relative input electrical power, measured on a halogen MR16 lamp with a nominal CCT of 3000K, according to some embodiments.

FIG. 1C shows a shift in correlated color temperature (CCT) versus relative output optical power, measured on a halogen MR16 lamp with a nominal CCT of 3000K, according to some embodiments.

FIG. 2A presents color point regions superimposed over a CIE 1976 u′v′ color diagram, showing an example implementation for a system configured for emulating dimming curves over the CCT range ˜2100K-2800K using temperature-sensitive wavelength-converting materials, according to some embodiments.

FIG. 2B presents a color gamut superimposed over a CIE 1976 u′v′ color diagram, for a system configured for emulating dimming curves over the CCT range ˜2100K-2800K using temperature-sensitive wavelength-converting materials, according to some embodiments.

FIG. 2C presents a color gamut superimposed over a CIE 1976 u′v′ color diagram, for a system configured for emulating dimming curves over the CCT range ˜2100K-2800K using temperature-sensitive wavelength-converting materials, according to some embodiments.

FIG. 2D presents color point regions superimposed over a CIE 1976 u′v′ color diagram, for a system configured for emulating dimming curves over the CCT range ˜1700K-2000K using temperature-sensitive wavelength-converting materials, according to some embodiments.

FIG. 3 shows a series of intensity curves showing variation of intensity over a wavelength range as exhibited by systems for emulating dimming curves using temperature-sensitive wavelength-converting materials, according to some embodiments.

FIG. 4A shows a u′v′ color-shift scatter plot showing a selection of power level measurements taken using a system configured for emulating dimming curves using temperature-sensitive wavelength-converting materials, according to some embodiments.

FIG. 4B shows color rendering examples superimposed over a u′v′ color-shift scatter plot showing a selection of temperature measurements taken using a system configured for emulating dimming curves using temperature-sensitive wavelength-converting materials, according to some embodiments.

FIG. 5A shows a CCT versus power scatter plot as exhibited by systems for emulating dimming curves using temperature-sensitive wavelength-converting materials, according to some embodiments.

FIG. 5B shows a CCT versus temperature scatter plot as exhibited by systems for emulating dimming curves using temperature-sensitive wavelength-converting materials, according to some embodiments.

FIG. 6A shows a CRI versus power scatter plot as exhibited by systems for emulating dimming curves using temperature-sensitive wavelength-converting materials, according to some embodiments.

FIG. 6B shows a CRI versus temperature scatter plot as exhibited by systems for emulating dimming curves using temperature-sensitive wavelength-converting materials, according to some embodiments.

FIG. 7A shows a u′v′ color-shift scatter plot showing a selection of power level measurements taken when using additional systems configured for emulating dimming curves using temperature-sensitive wavelength-converting materials, according to some embodiments.

FIG. 7B shows a CCT versus power scatter plot as exhibited by additional systems for emulating dimming curves using temperature-sensitive wavelength-converting materials, according to some embodiments.

FIG. 7C shows a Ra versus power scatter plot as exhibited by additional systems for emulating dimming curves using temperature-sensitive wavelength-converting materials, according to some embodiments.

FIG. 7D shows a R9 versus power scatter plot as exhibited by additional systems for emulating dimming curves using temperature-sensitive wavelength-converting materials, according to some embodiments.

FIG. 8 shows an electronically-controlled multi-string dimming approach that can be used in conjunction with systems that emulate dimming curves using temperature-sensitive wavelength-converting materials.

FIG. 9 shows a white locus according to an experimentally-determined white locus, as pertaining to some embodiments.

FIG. 10 shows the emission spectrum of a white LED with a CCT of 3000K and a CRI of about 90, and the emission and absorption spectra of a saturable red phosphor, according to some embodiments.

FIG. 11 shows a possible way to combine such a white LED with such a saturable phosphor, according to some embodiments.

FIG. 12A and FIG. 12B show the resulting spectral and colorimetric properties of a lighting system, according to some embodiments.

### DETAILED DESCRIPTION

Reference is now made in detail to certain embodiments. The disclosed embodiments are not intended to be limiting of the claims.

In one embodiment of a lighting system of the present invention comprises: (a) at least one light emitting diode (LED) light source, the light source being configured to receive variable power; (b) a first phosphor for converting light; and (c) a second phosphor for converting light, the second phosphor having a conversion efficiency which varies as the power varies; (d) wherein light from the LED, the first phosphor and the second phosphor combine to form emitted light. Each of these elements is considered below in greater detail.

The LED light source functions to provide the primary source of light or flux to excite the first and/or second phosphors, and to contribute to the emitted light. The LED light source is configured to receive variable power such that its optical output varies. Suitable LED and their associated drive circuitry are well known, and, thus, the details of which are not described herein. Suffice to say that the LEDs can be used in any conventional configuration, including, for example, individual LED and LED array configurations. Additionally, suitable LEDs include LEDs, OLEDs, laser diodes, and LED/laser diode combinations.

Although any LED may be used, typically LEDs having a shorter wavelength such as violet or blue LEDs are preferred (although are not necessary) as they tend to have higher excitation energy for exciting the first and second phosphors as described below. In one particular embodiment, the LED is a violet LED, which Applicants have discovered have various advantages. They may exhibit unusually-high wall-plug efficiency at high current density and high temperature, which makes them desirable as pump LEDs for some lighting systems. In addition, violet LEDs enable a white-balanced spectrum at various CCTs having little or no blue light. This can be desirable in some applications where varying CCT is sought. In one embodiment, the LED is a bulk GaN LED configured to emit light having a wavelength of about 400 nm to 460 nm. Such LEDs are commercially available from Soraa Inc (Freemont, Calif.). Other embodiments will be known or obvious to those of skill in the art in light of this disclosure.

In one embodiment, the LED light source receives variable power. As mentioned above, drivers for providing variable power to the LED devices are well known. The variable power may range from a relatively low power to a relatively high power. Generally, although not necessarily, the ratio of low to high power will be at least 1:2, and, in one particular embodiment, 1:10, or 1:100 , or more. Such large ratios are typical in deep-dimming applications where the user may dim light to a very low level. In the case of conventional (filament) lights, such dimming ratios are associated with a shift of the light's color temperature, as will be illustrated below. These color temperature shifts are familiar to users, and therefore it can be desirable to emulate them with LED systems. Other embodiments will be known or obvious to those of skill in the art in light of this disclosure.

As is known, applying variable power to the LED light source will result in certain effects. First, as the power increases/decreases, the light output or flux of the LED device increases/decreases, respectively. Second, as the power increases/decreases, overall heat generated by the light system increases/decreases. It should be understood that the heat may be emitted not only from the LED, but also from the drive circuitry, phosphors, and other components of the light system. The heat naturally affects the temperature of the phosphors and other components of the light system. These effects are referred to herein as the “driving conditions” of the phosphors. For example, in one embodiment, the driving condition may be the optical flux exciting the phosphor, and in another embodiment, the driving condition may the temperature of the phosphor. In an alternative embodiment, the light system comprises a temperature-control heating element that is dependent on the LED power level. Thus, heat from this element may also be a driving condition for a temperature dependent phosphor.

The phosphors or other wavelength-converting materials (collectively referred to as “phosphors”) function to convert light from one wavelength to one or more different wavelengths. This is a well-known function of phosphors. In various embodiments, the phosphors may be optically excited by light from LED emitters, from other phosphors, or by a combination thereof

In the present invention, at least one of the phosphors reacts to the effect(s) of varying power (i.e., the driving conditions as described above) to alter the color of the emitted light. Specifically, as the power decreases, the longer wavelength emissions increase relative to the shorter wavelength emissions from the phosphor(s) in the emitted light. Likewise, as the power increases, the longer wavelength emissions decrease relative to the shorter wavelength emissions of the phosphor(s) in the emitted light. In one embodiment, the result of this is emitted light that mimics the color changing effect caused by dimming of a tungsten filament.

As mentioned above, the effect can be described as a lowering of CCT along the blackbody curve from a nominal 2800K at full power to 2000-2200K at 10% dimming. Other CCT ranges can be considered, in order to emulate a variety of systems having variable color temperature. This includes emulation of halogen lamps (typically having a CCT of 3000K at full power), or of natural daylight (whose CCT may vary in a wide range from 3000K to 10.000K or more, depending on time of the day)

Various embodiments of phosphors may be used that have a conversion efficiency that varies with varying power to the LED. As used herein, the term “conversion efficiency” of the phosphor is the product of two terms: absorption efficiency and quantum yield for conversion. In some embodiments, the absorption efficiency (i.e. the absorption coefficient) depends on the driving conditions (e.g. in the case of a saturable phosphor, in which the absorption decreases as exciting flux increases). In some embodiments, the quantum yield depends on the driving conditions (e.g., in the case of a phosphor which has a quantum yield that is temperature-dependent).

In the case of phosphors having saturable absorption, the saturation may be caused by a long lifetime of carriers (electrons) optically excited in the phosphor—also termed the decay time of the phosphor. For instance, the lifetime may be longer than 1 us (e.g., it may be 1 us, 10 us, 100 us, 1 ms, etc . . . ). For a given lifetime, the saturation will occur at an inversely proportional optical excitation flux. A phosphor having a specific lifetime may be selected. An example of a flux-saturable phosphor is magnesium fluoro-germanate (MFG) family.

In the case of the phosphors having a temperature-dependent quantum yield, the output tends to decrease as its temperature increases. For example, the quantum yield may vary from 95% at room temperature to 50% at a high temperature (such as 100C, 150C, 200C); such variations mean that the amount of light emitted by the phosphor is roughly halved between room temperature and high temperature. This may correspond to a significant shift of CCT for the light emitted by the lighting system—for instance, a shift of 500K, 1000K or 2000K or more.

Other effects may induce a dependence of conversion efficiency versus driving conditions. For instance, the absorption spectrum of a phosphor may undergo a spectral shift with temperature; likewise, LED wavelength usually shifts with temperature (typically by a few nm over a temperature range of 100C). These shifts may be sufficient to significantly alter the net absorption of a phosphor at a given wavelength, for instance by offsetting the emission wavelength of pump LEDs and the peak absorption of the phosphor. Thus, the net excitation of the phosphor by the pump LED may vary with temperature. Phosphor materials having a such a temperature-dependent behavior may include semiconductor quantum dots.

Another possible effect is a temperature-induced shift in the emission spectrum of a phosphor. For instance, a red phosphor may have a spectrum that shifts to longer-wavelength with higher temperature. Such shift may be caused by the rigid shift of the shape of the spectrum towards longer wavelength. Such a shift may be caused by a change in shape (for instance, if several optical transitions make up the phosphor spectrum and the relative intensities of these transitions varies with temperature).

Various configurations of the phosphors may be used to alter the color of the emitted light as power to the LED device varies. For example, one or more of the following phosphor configurations may be used: temperature-sensitive orange or red phosphor, for which emission intensity decreases with increasing LED power (and temperature); photo-sensitive orange or red phosphor, for which emission decreases with increasing photo-flux; temperature- and photo-sensitive orange or red phosphors to increase the amount of red intensity attenuation; wavelength-sensitive blue or green/yellow phosphors, for which conversion efficiency increases with increasing or decreasing driving conditions, thereby increasing the blue/yellow intensity relative to the orange or red intensity; color-shifting red, orange, green/yellow or blue phosphors, for which emission shifts to decreasing u′ or v′ values with increasing temperature or photo-flux, such that the combined color shifts in the desired direction; any number of other non-saturated phosphor combinations that result in a balance between orange or red and the rest of the spectrum decreasing with dimming; temperature- or photo-sensitive filter materials that subtract red with increasing temperature/photo-flux; infrared-emitting phosphors or quantum dots that have temperature or photo-sensitive absorption in the red spectral region; up-conversion materials with temperature- or photo-sensitive red absorption; temperature-sensitive dyes with red absorption; temperature quenching red down-converting material, such as an organic dye or quantum dot such as CdSe, InP, and other materials including various Cd-free materials; and combinations of any of the foregoing that results in the desired effect.

In one embodiment, the first and second phosphors emit light of different wavelengths. For example, in one embodiment, one phosphor emits light in the blue/green/yellow spectrum, while the other emits light in the orange/red spectrum. The desired color change for varying output can be achieved by the different phosphors emitting their light at different intensities: at lower power, light in the blue/green/yellow spectrum can decease relative to light in the orange/red spectrum or light in the orange/red spectrum can increase relative to the light in blue/green/yellow spectrum, and at higher power, light in the blue/green/yellow spectrum can increase relative to light in the orange/red spectrum or light in the orange/red spectrum can decrease relative to the light in blue/green/yellow spectrum. Thus, either phosphor (relatively short or long wavelength) can affect the color of the emitted light at different power levels. Thus, the second phosphor, which has varying conversion efficiency (i.e. its output changes as the power varies), may be either the phosphor emitting a relatively short wavelength (e.g., in the blue/green/yellow spectrum), or the phosphor emitting a relatively long wavelength (e.g. in the orange/red spectrum). In one embodiment, the second phosphor emits a relatively long wavelength compared to the first wavelength. In one embodiment, the second phosphor is a red or an orange phosphor.

Although only second phosphor needs to have varying conversion efficiency, it should be understood that the first phosphor may have varying conversion efficiency too. In this embodiment, the effects of the varying conversion efficiency of the first phosphor preferably (although not necessarily) do not counteract the effects of the varying conversion efficiency of the second phosphor.

The compositions of phosphors or other wavelength-converting materials referred to in the present disclosure (collectively referred to as “phosphors”) comprise any combinations of known wavelength-converting materials. Suitable phosphors are well know. Wavelength conversion materials can be crystalline (single or poly), ceramic or semiconductor particle phosphors, ceramic or semiconductor plate phosphors, organic or inorganic down converters, up converters (anti-stokes), nano-particles and other materials which provide wavelength conversion. Examples of major classes of down converter phosphors used in solid-state lighting include garnets doped at least with Ce3+; nitridosilicates or oxynitridosilicates doped at least with Ce3+; chalcogenides doped at least with Ce3+; silicates or fluorosilicates doped at least with Eu2+; nitridosilicates, oxynitridosilicates or sialons doped at least with Eu2+; carbidonitridosilicates or carbidooxynitridosilicates doped at least with Eu2+; aluminates doped at least with Eu2+; phosphates or apatites doped at least with Eu2+; chalcogenides doped at least with Eu2+; and oxides, oxyfluorides or complex fluorides doped at least with Mn4+. Specific examples of phosphors include, for example, one or more of the following: (Ba,Sr,Ca,Mg)5(PO4)3(Cl,F,Br,OH):Eu2+, Mn2+; (Ca,Sr,Ba)3MgSi208:Eu2+, Mn2+; (Ba,Sr,Ca)MgAl10017:Eu2+, Mn2+; (Na,K,Rb,Cs)2[(Si,Ge,Ti,Zr,Hf,Sn)F6]:Mn4+; (Mg,Ca,Zr,Ba,Zn) [(Si,Ge,Ti,Zr,Hf,Sn)F6]:Mn4+; (Mg,Ca,Sr,Ba,Zn)2SiO4:Eu2+; (Sr,Ca,Ba)(Al,Ga)2S4:Eu2+; (Ca,Sr)S:Eu2+,Ce3+; (Y,Gd,Tb,La,Sm,Pau)3(Sc,Al,Ga)5O12:Ce3+; and combinations of two or more thereof

Other examples of phosphors include, for example, one or more of the following: Ca1−xAlx−xySi1−x+xyN2−x−xyCxy:A; Ca1−x−zNazM(III)x−xy−zSi1−x+xy+zN2−x−xyCxy:A; M(II)1−x−zM(I)zM(III)x−xy−zSi1−x+xy+zN2−x−xyCxy:A; M(II)1−x−zM(I)zM(III)x−xy−zSi1−x+xy+zN2−x−xy−2w/3CxyOw−v/2Hv:A; M(II)1−x−zM(I)zM(III)x−xy−zSi1−x+xy+zN2−x−xy−2w/3−v/3CxyOwHv:A; and combinations or two or more thereof; wherein 0<x<1, 0<y<1, 0≦z<1, 0≦v<1, 0<w<1, x+z<1, x>xy+z, and 0<x−xy−z<1, M(II) is at least one divalent cation, M(I) is at least one monovalent cation, M(III) is at least one trivalent cation, H is at least one monovalent anion, and A is a luminescence activator doped in the crystal structure.

Still other examples of phosphors include, for example, one or more of the following: LaAl(Si6−z Al z)(N10−z Oz):Ce3+(wherein z=1); (Mg,Ca,Sr,Ma)(Y,Sc,Gd,Tb,La,Lu)2S4:Ce3+; (Ba,Sr,Ca)xxSiyNz:Eu2+ (where 2x+4y=3z); (Y,Sc,Lu,Gd)2−nCanSi4N6+nCl-n:Ce3+, (wherein 0≦n≦0.5); (Lu,Ca,Li,Mg,Y) a-SiAlON doped with Eu2+ and/or Ce3+; (Ca,Sr,Ba)SiO2N2:Eu2+,Ce3+; (Sr,Ca)AlSiN3:Eu2+; CaAlSi(ON)3:Eu2+; (Y,La,Lu)Si3N5:Ce3+; (La,Y,Lu)3Si6N11:Ce3+; and combinations of two or more thereof.

For purposes of the application, it is understood that when a phosphor has two or more dopant ions (i.e. those ions following the colon in the above phosphors), this is to mean that the phosphor has at least one (but not necessarily all) of those dopant ions within the material. That is, as understood by those skilled in the art, this type of notation means that the phosphor can include any or all of those specified ions as dopants in the formulation.

Further, it is to be understood that nanoparticles, quantum dots, semiconductor particles, and other types of materials can be used as wavelength converting materials. The list above is representative and should not be taken to include all the materials that may be utilized with embodiments described herein.

Those of skill in the art will be able to select suitable first phosphors having the above-described properties from the phosphor lists above in light of this disclosure. Likewise, those of skill in the art will be able to select suitable second phosphors having the desired conversion efficiencies in light of this disclosure. For example, suitable temperature-sensitive quantum yield phosphors include europium-doped alkaline earth ortho-silicate orange phosphor with peak wavelength of 605 nm; suitable temperature-sensitive emission spectrum phosphors include manganese-doped alkaline earth germanium oxy-fluoride red phosphor with peak wavelength of 659 nm; and suitable flux-sensitive phosphors include Mn-doped phosphors such as K2[TiF6]:Mn4+. Still other embodiments will be known or obvious to those of skill in the art in light of this disclosure.

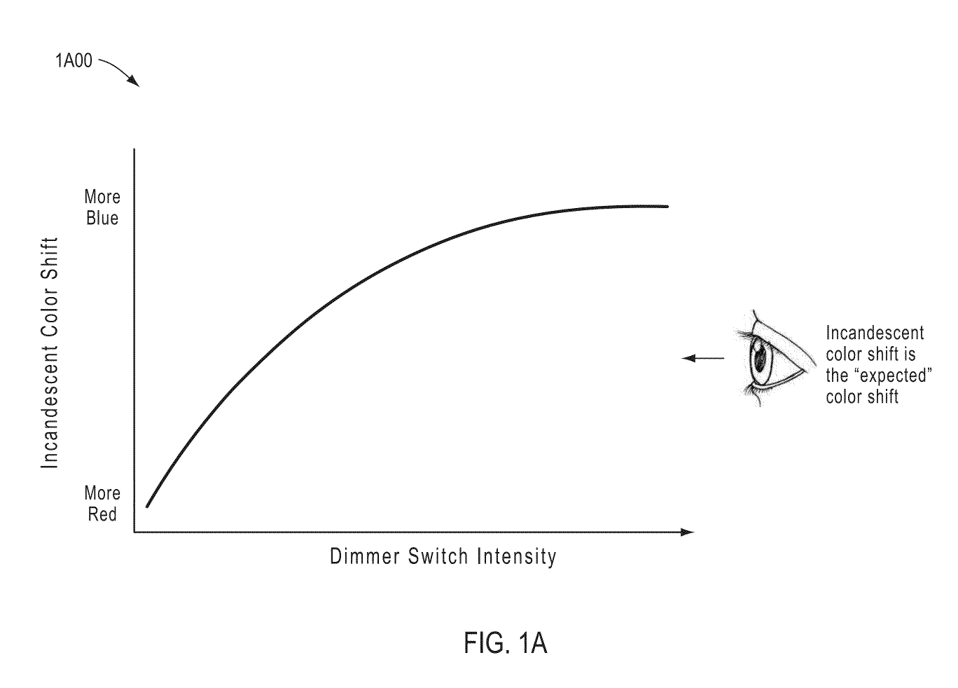

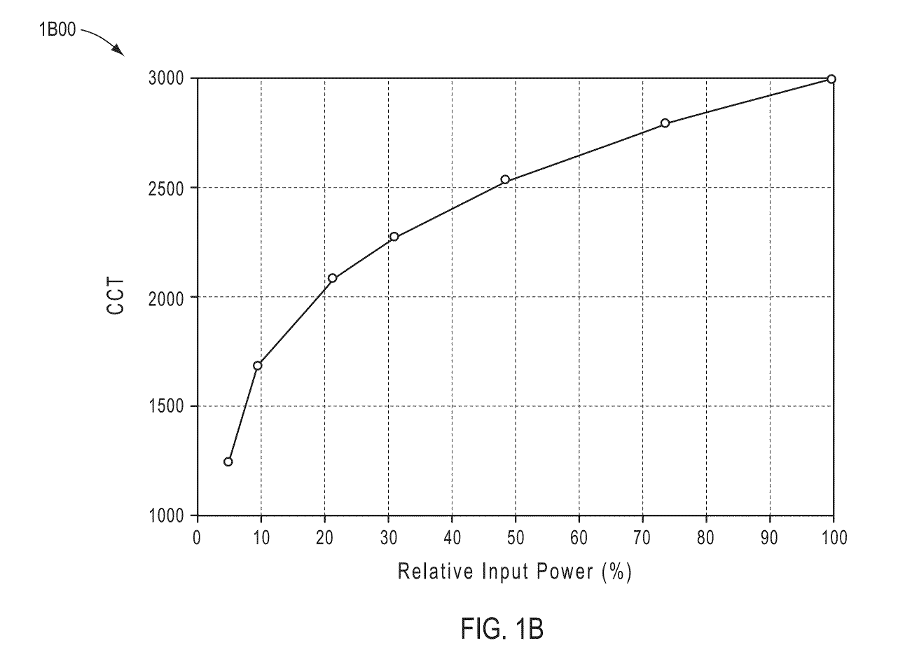

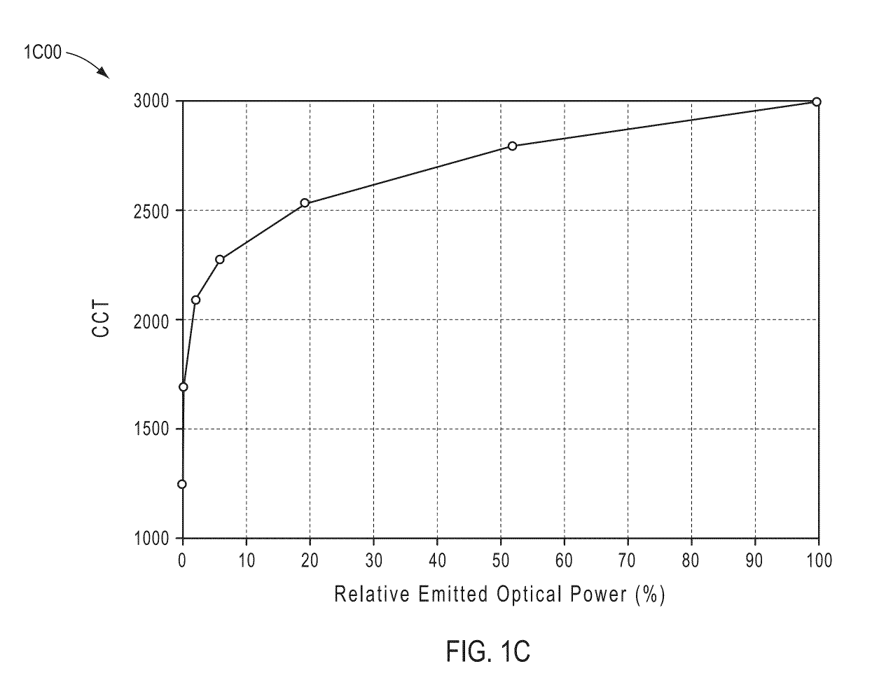

FIG. 1A depicts an expected color shift 100 to be achieved by emulating dimming curves using temperature-sensitive wavelength-converting materials.

FIG. 1B depicts a measured (CCT) shift as a function of relative input electrical power, for a halogen MR16 with a nominal CCT of 3000K at full power. FIG. 1B shows that the shift is not linear with input power. Embodiments of the invention may follow a behavior similar to that of FIG. 1B. For example, for a same relative input electrical power, embodiments may have a CCT that is within +/−250 K of the CCT shown on FIG. 1B.

FIG. 1C depicts a measured (CCT) shift as a function of relative output optical power, for a halogen MR16 with a nominal CCT of 3000K at full power. FIG. 1C shows that the shift is not linear with output power. Embodiments of the invention may follow a behavior similar to that of FIG. 1C. For example, for a same relative output optical power, embodiments may have a CCT which is within +/−250 K of the CCT shown on FIG. 1C.

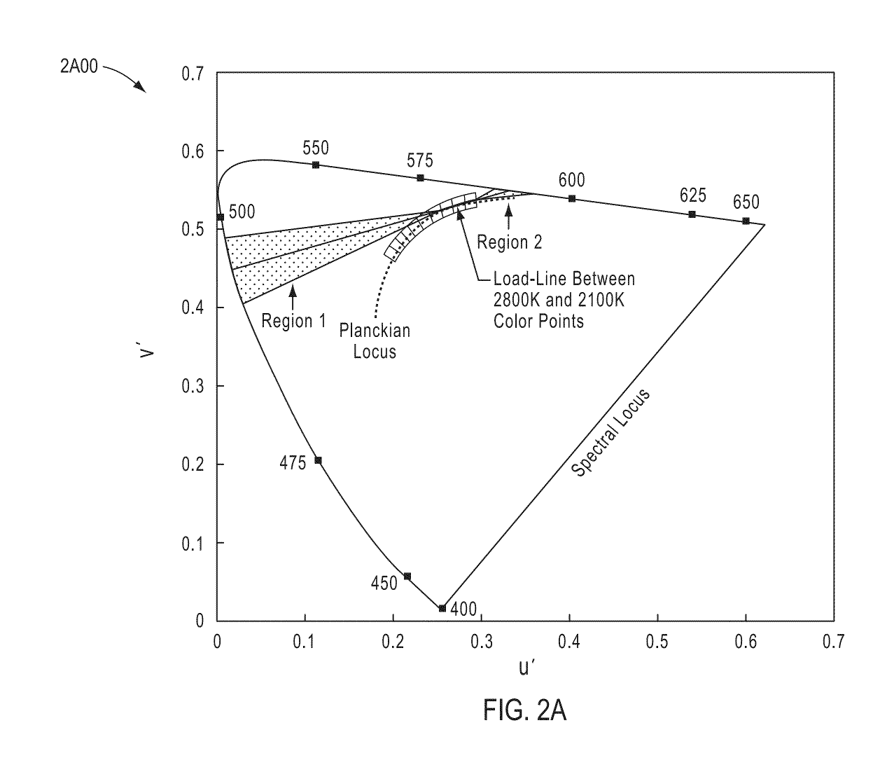

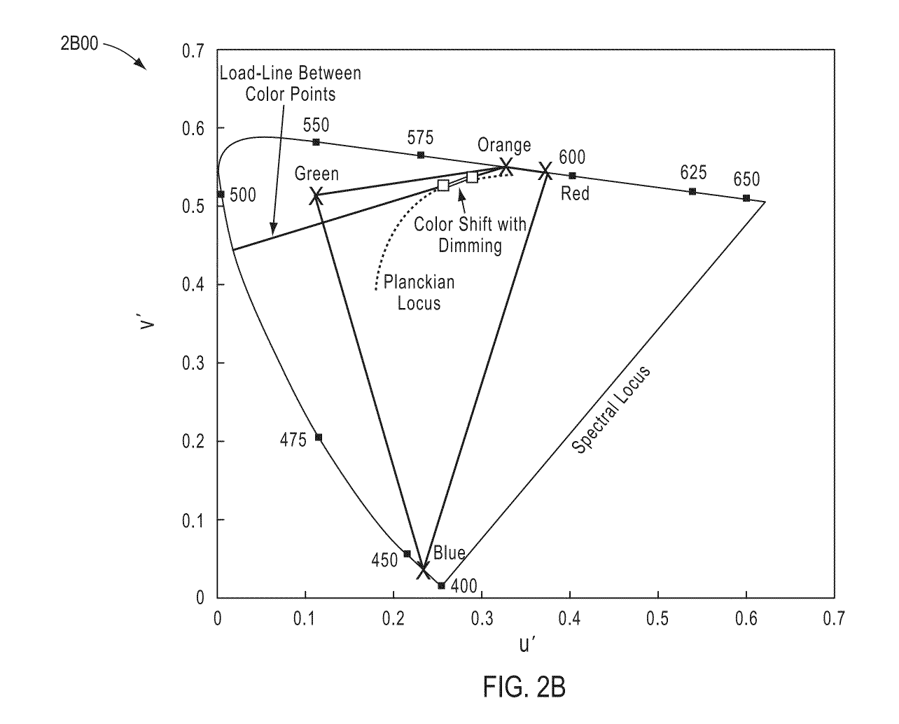

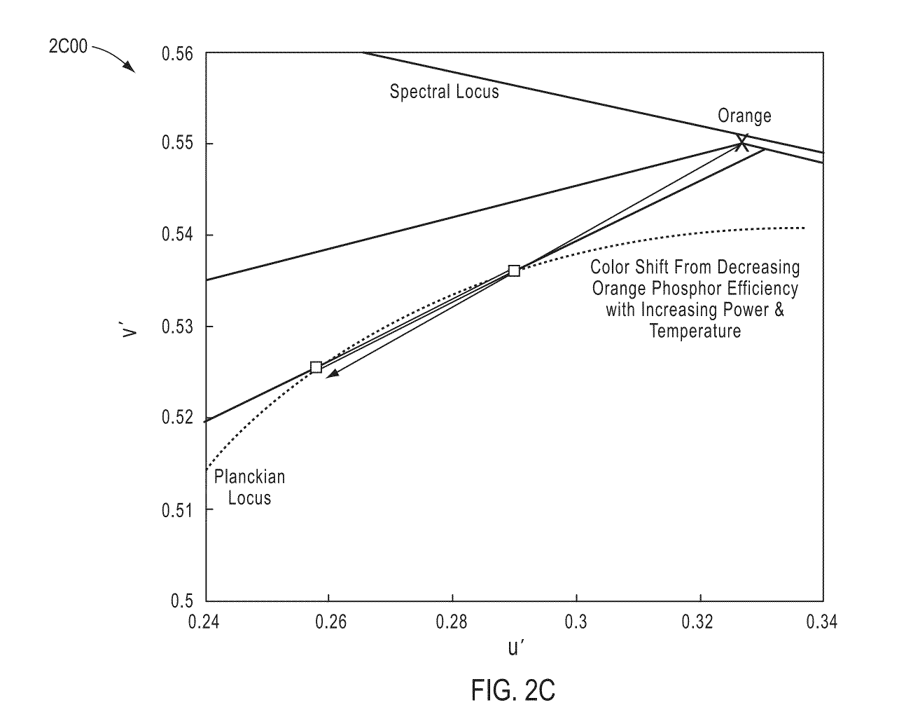

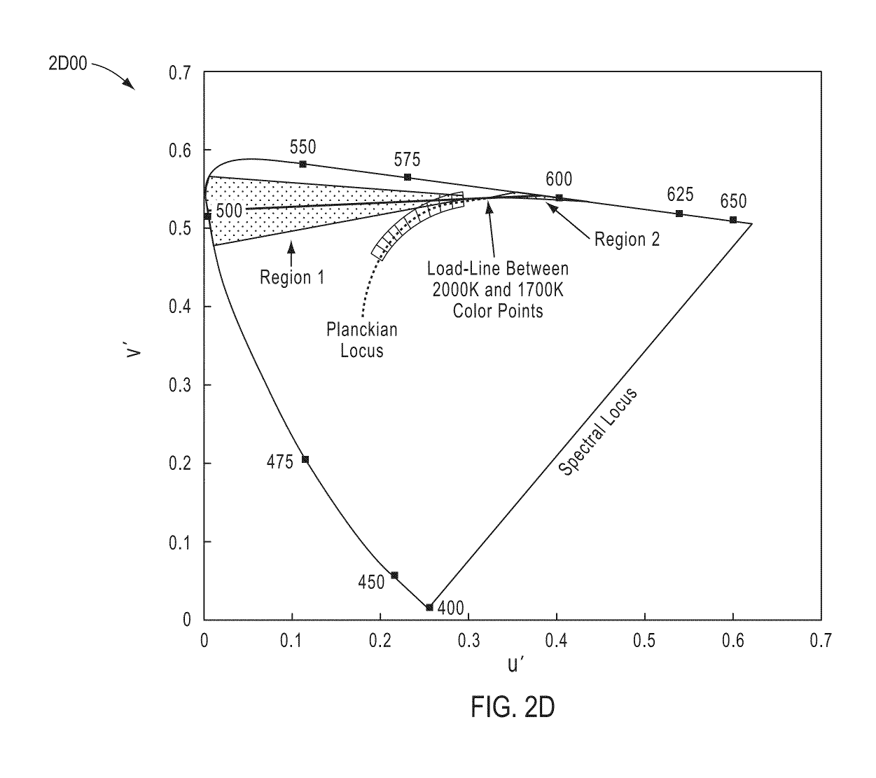

FIG. 2A presents color point regions superimposed over a CIE 1976 u′v′ color diagram, showing an example implementation for a system configured for emulating dimming curves over the CCT range ˜2100K-2800K using temperature-sensitive wavelength-converting materials, according to some embodiments.

Upon dimming from full-power to <10% power, the contribution of the emission from phosphor(s) with color points that fall within Region 2 must decrease with respect to the intensity of phosphor(s) within Region 1 in order to emulate CCT-change along the blackbody. Such a change may be carried out by either increasing Region 1 phosphor(s) intensity with respect to stable phosphor(s) within Region 2 or by decreasing Region 2 phosphor(s) intensity with respect to stable phosphor(s) within Region 1. In order to reproduce a continuous CCT- change, the trade-off between phosphor intensities within these two regions must also be continuous.

This approach may be implemented using either single or multiple phosphors within each region or multiple phosphors that may fall outside the regions in which the composite color falls within the regions. As an example, as shown in FIG. 2B and FIG. 2C, temperature-stable blue phosphors may be combined in appropriate proportion to target a color point within Region 1. These two phosphors may then be paired with a yellow-orange phosphor within Region 2, for which the intensity varies with dimming. A fourth temperature-stable red phosphor may be added to expand the color gamut in order to appropriately mix the full-power color point. The color of this system shifts due to the decreasing orange phosphor efficiency (in this case, quantum yield) with increasing power and temperature.

The case of dimming at lower CCT values (1700K to 2000K) is illustrated in FIG. 2D. Because the slope of the blackbody curve in CIE 1976 u′v′ color space between 1700K and 2000K is much shallower than between 2100K and 2800K, new regions are specified to vary color along the new load-line shown in FIG. 2D.

The implementations illustrated in FIG. 2A and FIG. 2D may be combined to emulate dimming from a CCT of 1700K to 2800K along the blackbody. As an example, stable phosphor(s) with a color point in the overlap between Region 1 in FIG. 2A and Region 1 in FIG. 2B may be paired with down-converting material(s) in Region 2 in FIG. 2D, for which the intensity varies substantially at dimming conditions<10%. Additionally, phosphor(s) in Region 2 in FIG. 2A, for which the intensity varies at conditions>10%, may be added to emulate dimming in both CCT ranges.

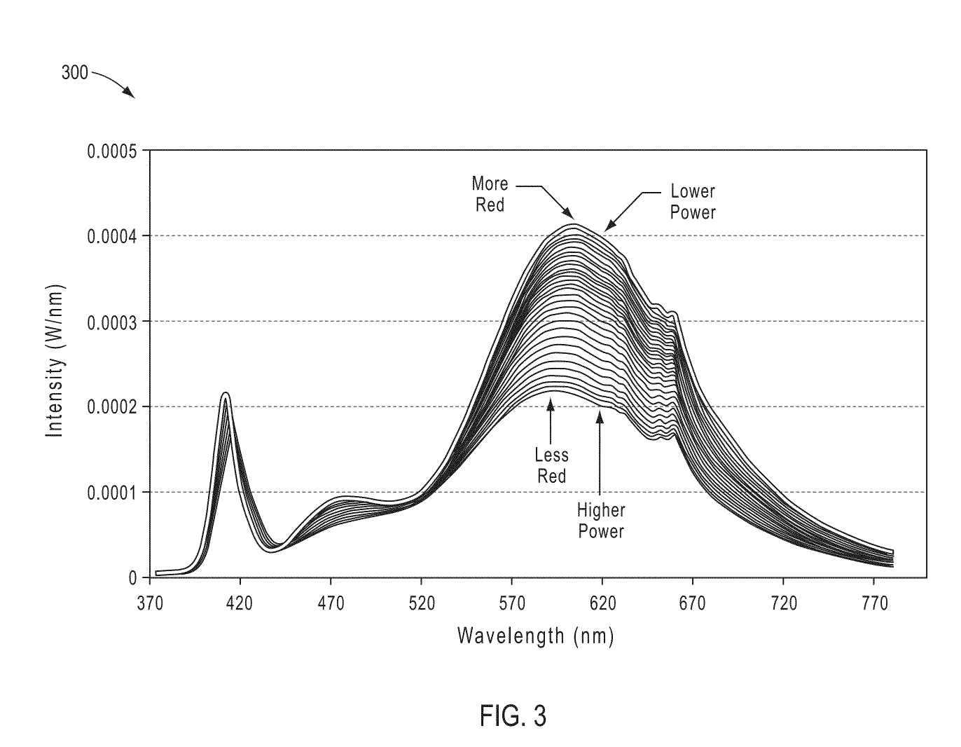

FIG. 3 shows a series of intensity curves 300 showing variation of intensity over a wavelength range as exhibited by systems for emulating dimming curves using temperature-sensitive wavelength-converting materials. As shown, the intensities of the yellow-orange, orange and red regions of the spectra (at wavelengths >˜575 nm) decreased in comparison to the other spectral regions.

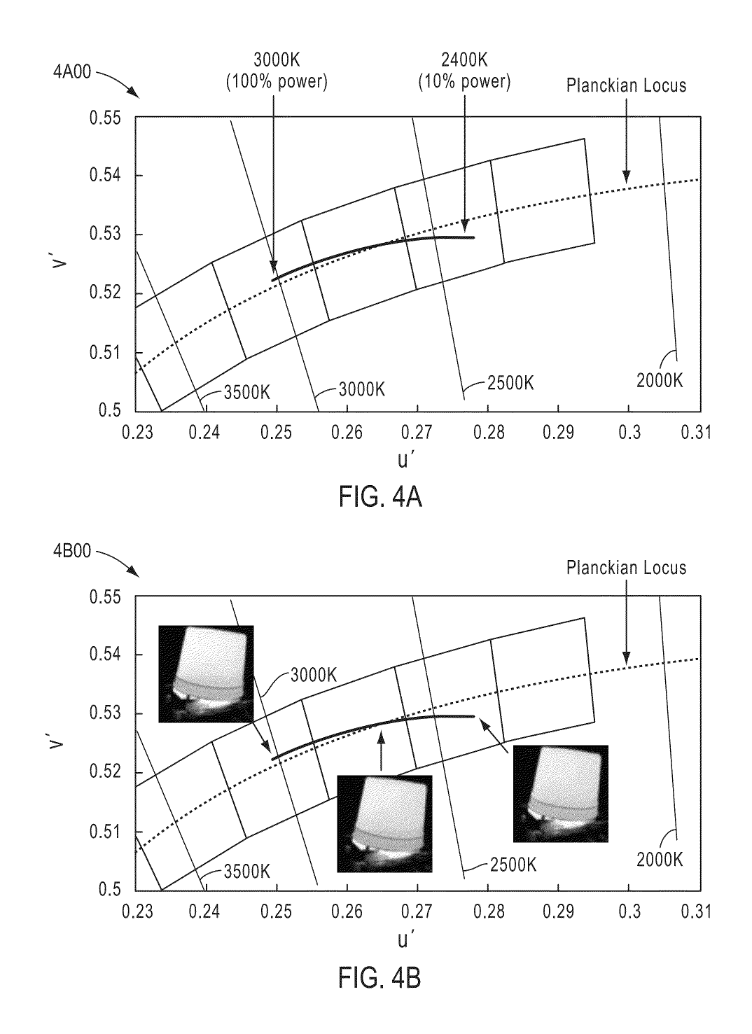

FIG. 4A is one example of an embodiment with both temperature-sensitive red and orange phosphors. This example consists of a violet-emitting diode with peak wavelength at 415 nm and four wavelength-converting materials, including europium-doped alkaline earth silicate blue phosphor with peak wavelength of 465 nm, cerium-doped rare-earth aluminum garnet green phosphor with peak wavelength of 510 nm, europium-doped alkaline earth ortho- silicate orange phosphor with peak wavelength of 605 nm, and manganese-doped alkaline earth germanium oxy-fluoride red phosphor with peak wavelength of 659 nm were mixed in a weight percent ratio of 100:31:65:15. The relative phosphor loadings were chosen to target a CCT of 3000K on the Planckian locus at full-power. When the part was dimmed, the CCT approximately followed the Planckian locus down to a CCT of ˜2400K at 10% dimming, as shown.

The color-shifting behavior was implemented by taking advantage of two properties of the wavelength-converting materials: (1) the larger thermal quenching of emission intensity of the orange silicate compared to the other emissive materials and, (2) an increase in the probability of higher energy manganese transitions relative to the transition at 659 nm in the fluoride phosphor, which shifts the fluoride color point by (0.007, 0.001) in CIE 1976 uniform chromaticity space. As the electrical power to the light module was decreased, both the temperature of the phosphor and the violet flux density decreased, leading to a relative increase in the orange and red contents of the spectra. The CCT decreased, accordingly. The junction temperature of the LED in the light module used in this example varied between 25° C. and 125° C. from ˜1% to 100% drive power.

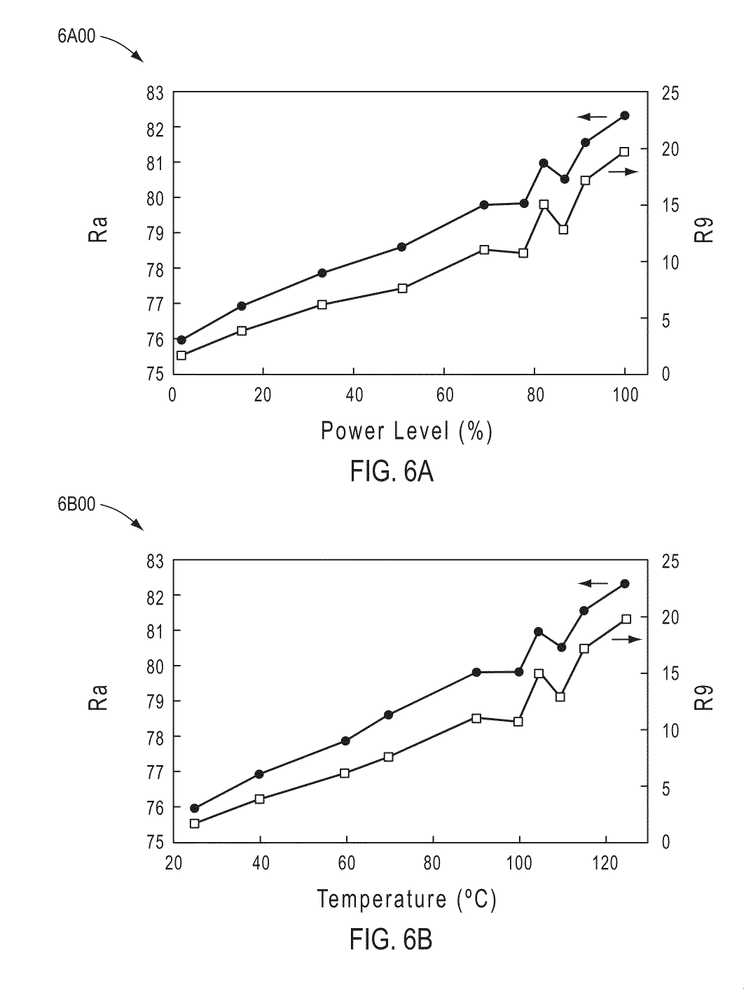

A similar embodiment consists of the same light source and phosphors as the example shown in FIG. 6A with relative loadings chosen to target a CCT between 3200K and 2700K to obtain CCTs of ˜2600K-˜2100K at 10% dimming, respectively.

FIG. 4B presents color rendering examples 4B00 superimposed over a u′v′ color-shift scatter plot 6B00 showing a selection of temperature measurements taken when using a system configured for emulating dimming curves using temperature-sensitive wavelength-converting materials.

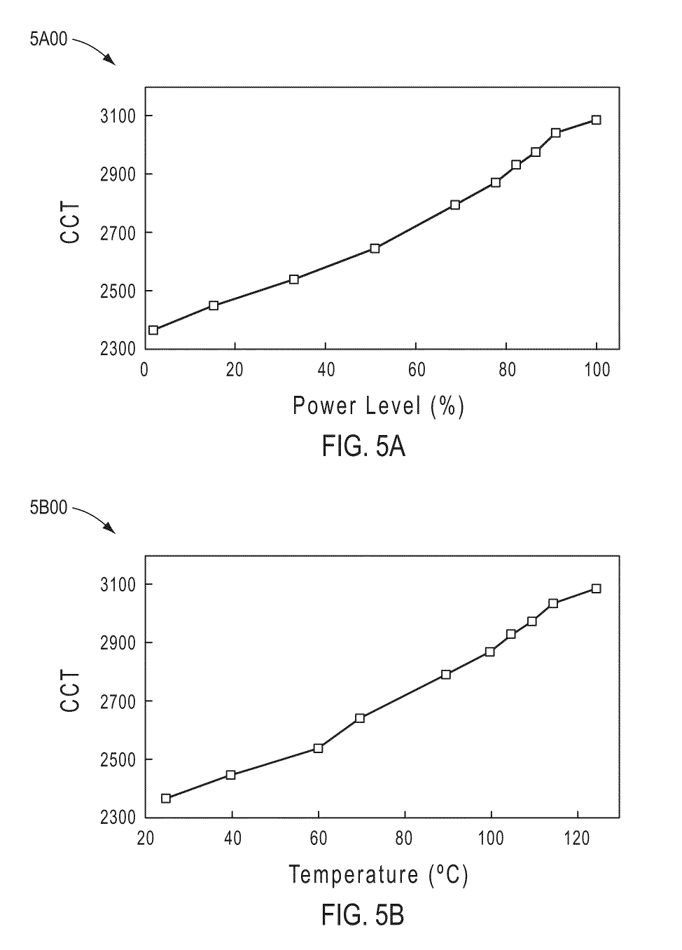

FIG. 5A presents a CCT versus power level scatter plot 5A00 as exhibited by systems for emulating dimming curves using temperature-sensitive wavelength-converting materials shown in FIG. 3A.

FIG. 5B presents a CCT versus LED diode junction temperature scatter plot 5B00 as exhibited by systems for emulating dimming curves using temperature-sensitive wavelength-converting materials.

FIG. 6A presents a color rendering indices (i.e., CRI) versus power level scatter plot 6A00 as exhibited by systems for emulating dimming curves using temperature-sensitive wavelength-converting materials shown in FIG. 3A.

FIG. 6B presents a CRI versus LED diode junction temperature scatter plot 6B00 as exhibited by systems for emulating dimming curves using temperature-sensitive wavelength- converting materials.

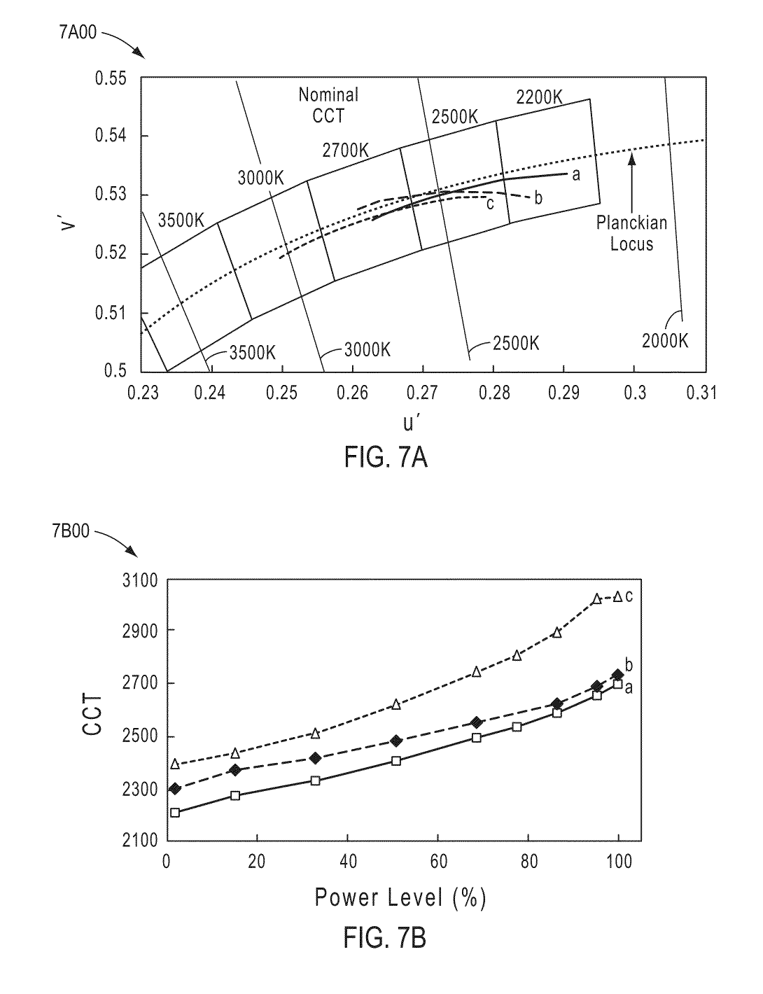

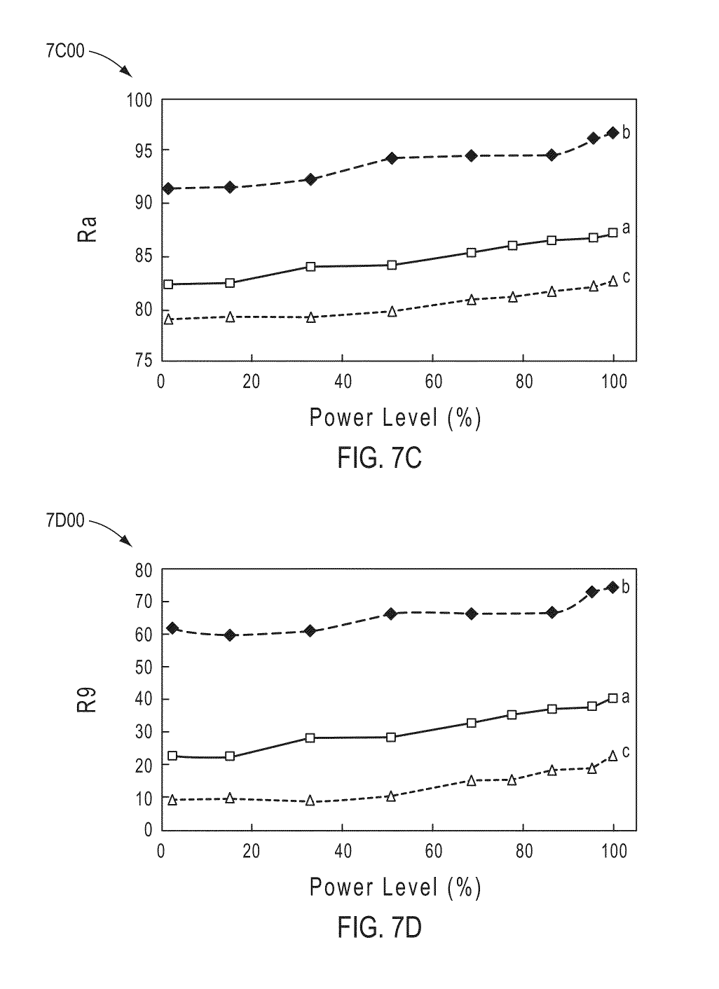

FIG. 7A presents a u′v′ color-shift scatter plot showing a selection of power level measurements taken when using additional systems configured for emulating dimming curves using temperature-sensitive wavelength-converting materials, according to some embodiments.

CRI values were tuned by changing the relative phosphor loadings. These examples included a violet light source with the same peak wavelength as the example shown in FIG. 6. These examples also consisted of four down-conversion materials, including the same blue and orange phosphors as the previous example. For these examples, a green cerium-doped rare-earth aluminum garnet with peak wavelength of 500 nm and a red europium-doped calcium aluminum silicon nitride (i.e., CASN) were used.

For samples a and c, a 650 nm peak CASN was used, and for sample b, a 655 nm peak CASN was used. The blue-to-green-to-orange-to-red phosphor loading ratios by weight were as follows: a: 100:508:183:43, b: 100:290:45:23, c: 100:498:175:25. The total weight of phosphors in each of the examples was set so that the fractional content of violet in their spectra (i.e., violet leakage) were the same for all three. The color rendering indices (i.e., CRI) for these examples were: a: Ra=87/R9=34, b: Ra=97/R9=74, c: Ra=83/R9=23. Thus, with the same light source and down-converting materials, including a temperature-sensitive orange phosphor and three temperature-stable phosphors, color rendering indices may be tuned by varying the phosphor loading ratio and the peak wavelength of the red phosphor.

For samples a and c, a 650 nm peak CASN was used, and for sample b, a 655 nm peak CASN was used. The blue-to-green-to-orange-to-red phosphor loading ratios by weight were as follows: a: 100:508:183:43, b: 100:290:45:23, c: 100:498:175:25. The total weight of phosphors in each of the examples was set so that the fractional content of violet in their spectra (i.e., violet leakage) were the same for all three. The CRI for these examples were: a: Ra=87/R9=34, b: Ra=97/R9=74, c: Ra=83/ R9=23. Thus, with the same light source and down-converting materials, including a temperature-sensitive orange phosphor and three temperature-stable phosphors, color rendering indices may be tuned by varying the phosphor loading ratio and the peak wavelength of the red phosphor.

FIG. 7B, FIG. 7C, and FIG. 7D present CCT, Ra and R9 values, respectively, as exhibited by additional systems for emulating dimming curves using temperature-sensitive wavelength-converting materials as a function of power level for the samples shown in FIG. 7A.

It will be apparent to those skilled in the art that many modifications, both to materials and methods, may be practiced without departing from the scope of the disclosure. For example, the aforementioned dimming capability can be incorporated into an MR-16 lamp, a PAR-30 lamp, an AR-111 lamp, etc., and/or any other known lamp, fixture, application, or form factor. Such lamps and fixtures include replacement and/or retro-fit directional lighting fixtures.

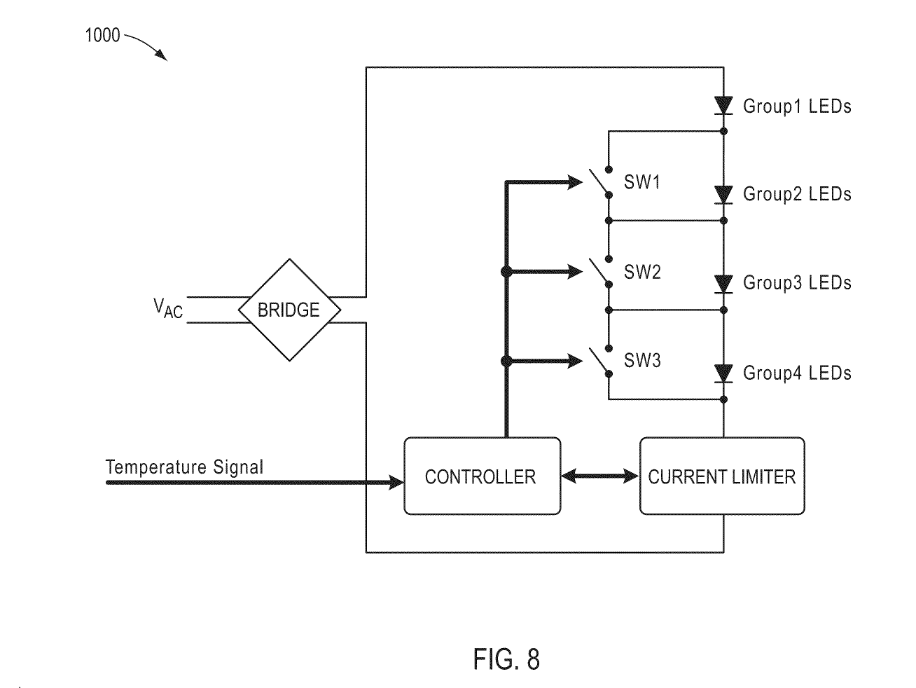

FIG. 8 depicts an electronically-controlled multi-string dimming approach 1000 that can be used in conjunction with systems that emulate dimming curves using temperature-sensitive wavelength-converting materials.

As already discussed, in some embodiments, it is desirable to closely match the behavior of an incandescent or halogen lamp—thus emulating the behavior of FIG. 1B and FIG. 1C. In this case, the chromaticity of the source may be very similar to that of a Blackbody radiator. This can be quantified by the conventional color distance formula Dxy=sqrt((x−x0)2+(y−y0) 2), where (x, y) is the chromaticity of the embodiment and (x0, y0) is the chromaticity of the Blackbody radiator with the same CCT. In some embodiments, Dxy is smaller than 1 point, 2 points, 3 points or another value. This expresses that such embodiments have a chromaticity similar to that of the Blackbody (Planckian) locus.

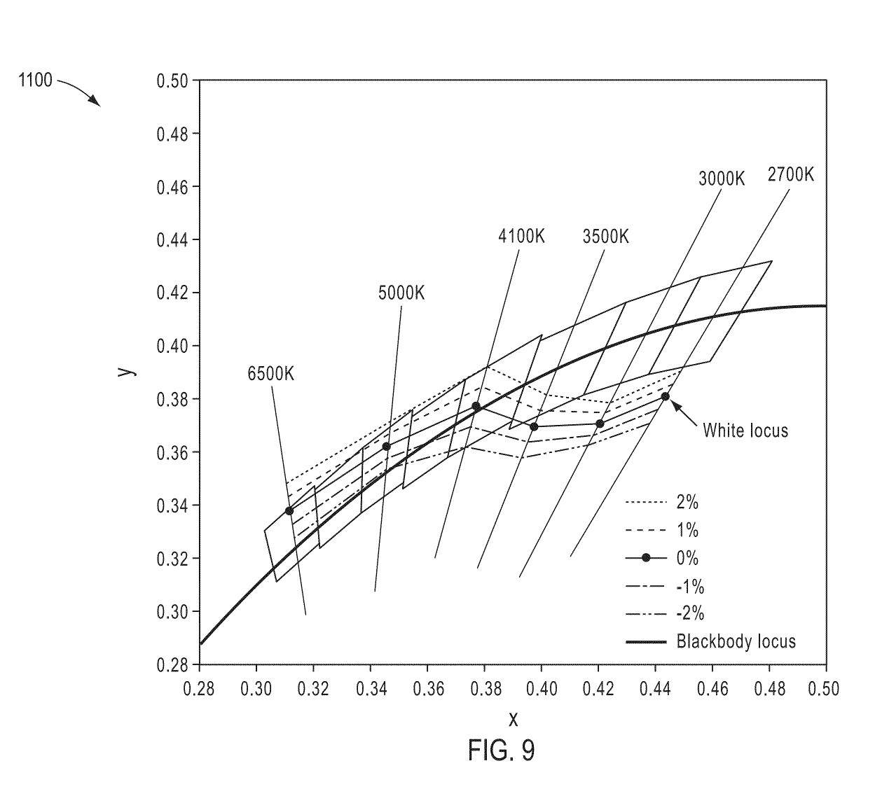

In some embodiments, the chromaticity is below the Planckian locus. For example, FIG. 9 shows a known-in-the-art white locus. See, for example, Rea and Freyssinier, Color Research and Application, 2011, 82-92. Lamps with chromaticities distinctly off of the Planckian locus could be judged acceptable by users, and sometimes even appeared whiter than on-Planckian sources of the same CCT. Such a user assessment has implications for sources of varying CCT. In such embodiments, the chromaticity shift occurs not following the Planckian locus but following a trajectory below the Planckian locus. For example, the trajectory may be the white locus of FIG. 9, or can be another trajectory in-between the Planckian locus and the white locus, or even a trajectory slightly below the white locus.

The chromaticity distance from the white locus can be characterized by the distance Dwhite=sqrt((x−xw)2+(y−yw)2) where (x, y) is the chromaticity of the embodiment and (xw, yw) is the chromaticity of the white locus at the same CCT as the embodiment. In some embodiments, this distance is smaller than a limit value such as 1 point, 2 points, 3 points. This expresses that such embodiments have a chromaticity similar to that of the white locus.

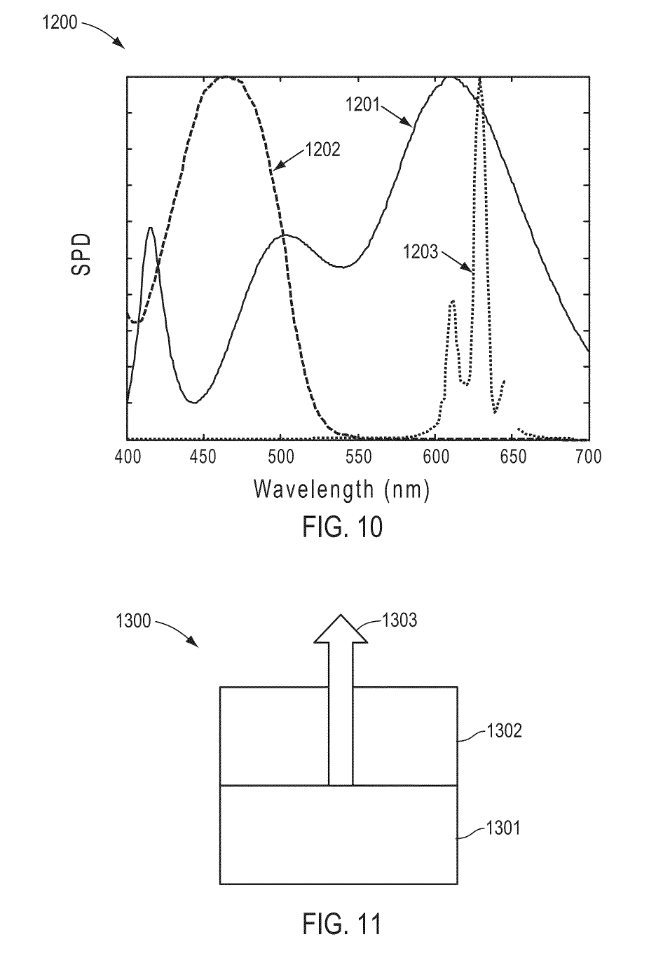

In addition to uses of the aforementioned temperature-sensitive phosphors flux-sensitive saturable phosphors can be employed to achieve CCT variations. Such an approach is illustrated in FIG. 10 through FIG. 12.

FIG. 10 shows the emission spectrum of a white LED with a CCT of 3000K and a CRI of about 90, and the emission and absorption spectra of a saturable red phosphor. This spectrum may be obtained by combining a violet-pump LED and several phosphors (e.g., a green phosphor, a red phosphor and possibly a blue phosphor). Curve 1202 is the absorption spectrum of a saturable red phosphor and curve 1203 is the corresponding luminescence spectrum. Spectra 1202 and spectra 1203 can be obtained, for example, with Mn-doped phosphors such as K2[TiF6]: Mn4+.

FIG. 11 shows a possible way to combine such a white LED with such a saturable phosphor. In FIG. 11, the saturable phosphor 1302 is placed above the LED 1301 so that the white light emitted by the LED 1303 can be absorbed by the saturable phosphor. Various other configurations are also possible. For example, the saturable phosphor may be mixed with the phosphors of the white LED or may be in a remote configuration.

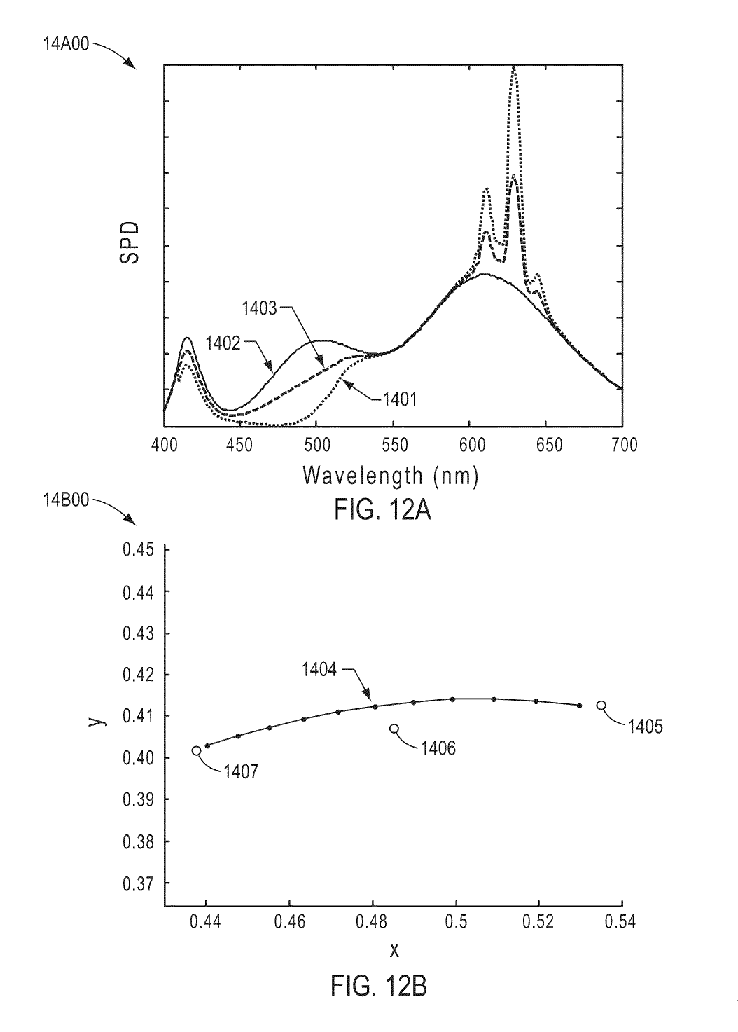

FIG. 12A and FIG. 12B show the resulting spectral and colorimetric properties of a lighting system. FIG. 12A shows the spectrum emitted by the system at various LED drive currents. At low drive current the saturable phosphor is not saturated and absorbs most of the light in its absorption range (e.g., blue-cyan light), resulting in spectrum 1401. At higher drive current the phosphor absorption is partially saturated and part of the blue-cyan light is transmitted, resulting in spectrum 1402. At even higher drive current the phosphor absorption is fully saturated, and the original spectrum of the white LED 1403 is emitted with very little perturbation from the circadian phosphor.

FIG. 12B shows the corresponding chromaticity in (x, y) space. At low drive current the CCT is about 2000K 1405, at higher drive current it is about 2500K 1406 and at the highest drive current it is about 3000K 1407. In all cases, the chromaticity is close to the Planckian locus 1404.

The embodiments of FIG. 10 through FIG. 12 achieve several desirable properties. At high drive current (e.g., see curve 1402), the embodiments behave like a conventional halogen retrofit with a high CCT. As the current is reduced (e.g., see curves 1403 and 1401), the chromaticity shifts toward lower CCT (from 1407 to 1406 to 1405) thus emulating the behavior of a dimmed halogen or incandescent lamp. In this embodiment, the presence of a violet pump is of importance since the violet light enables the chromaticity to be near-Planckian at low drive current, even in the absence of blue-cyan light.

Various aspects of this embodiment can be advantageously controlled. For example, the optical properties of the pump LED can be varied, and the selection of phosphors can be varied, and the relative loading of phosphors can be varied to accomplish an optimization objective. The optimization criteria may include the CRI of the source at various dimming levels, its chromaticity at various dimming levels. The loading of the saturable phosphor can be chosen so that its saturation occurs at a desired drive such as, for example, 10% dimming. In other embodiments, more than one saturable phosphor is used.

Embodiments may be integrated to various systems. This includes lighting systems (e.g., lamps, troffers and others) and non-lighting systems (e.g., display applications). Some of such applications are discussed hereunder. Various embodiments use different packages. In some cases the package is a COB package with multiple LEDs. In some cases it is a single-LED high-power package. In some cases it is a mid-power package, such as a lead frame package including one LED, two LEDs or more.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

What is claimed is:

1. A lighting system comprising
at least one light emitting diode (LED) light source, the light source being configured to receive an electrical power that varies;
a first phosphor for converting light; and
a second phosphor for converting light, the second phosphor having a conversion efficiency, which varies as the power varies;
wherein light from the LED, the first phosphor and the second phosphor combine to form emitted light.

2. The lighting system of claim 1, wherein varying the power causes at least one of flux exciting the second phosphor to vary, or temperature of the second phosphor to vary.

3. The lighting system of claim 2, wherein the variable power ranges from a relatively low power to a relatively high power, and wherein the conversion efficiency decreases as the variable power increases from the relatively low power to the relatively high power.

4. The system of claim 3, wherein the second phosphor is excited by an exciting light having an exciting flux and the conversion efficiency varies with the exciting flux.

5. The system of claim 4, wherein the conversion efficiency decreases as the flux increases

6. The system of claim 4, wherein the conversion efficiency varies through a change in absorption efficiency.

7. The system of claim 4, wherein the exciting light is light from at least one of the LED or the first phosphor.

8. The system of claim 1, wherein the emitted light is characterized by a CCT and an optical power, and wherein increasing the electric power varies the conversion efficiency causing the CCT to increase.

9. The system of claim 8, wherein the CCT varies within a range from 2000K to 6500K as the electrical power is varied.

10. The system of claim 8, wherein the CCT and the optical power vary according to a predetermined relationship.

11. The system of claim 10, wherein the predetermined relationship emulates the relationship between a CCT and optical power of a conventional filament lamp.

12. The system of claim 8, wherein the emitted light is characterized by a color rendering index chosen from Ra or R9, and wherein the color rendering index is maintained above a predetermined value as the electrical power is varied.

13. The system of claim 8, wherein the emitted light is characterized by a chromaticity, and the chromaticity remains within +/−0.010 (u′,v′) points from the Planckian locus as the electrical power is varied.

14. The system of claim 4, wherein the second phosphor is characterized by a radiative lifetime which is longer than 1 us.

15. The system of claim 3, wherein the second phosphor has is configured to emit a first spectrum at a first temperature and a second spectrum at a second temperature.

16. The system of claim 3, wherein the second phosphor has a quantum yield, and wherein the absolute value of the quantum yield varies by more than 10% between the first and the second temperatures.

17. The system of claim 16, wherein the first temperature is higher than the second temperature, the first spectrum is characterized by a first intensity, the second spectrum is characterized by a second intensity, and the first intensity is lower than the second intensity.

18. The system of claim 3, wherein variation of electrical power to the LED causes the second phosphor to vary in temperature.

19. The system of claim 18, wherein the emitted light is characterized by a CCT and an optical power, and wherein the variation in temperature of the second phosphor causes the CCT to increase as electrical power to the LED is increased.

20. The system of claim 1, wherein the second phosphor has a longer wavelength than the first phosphor.

21. The system of claim 20, wherein the second phosphor is an orange or red-emitting phosphor.

22. A method of varying color output from a lighting system comprising at least one light emitting diode (LED) light source, the light source being configured to receive electrical power, a first phosphor for converting light; and a second phosphor for converting light, the second phosphor having a conversion efficiency which varies as the electrical power varies, wherein light from the LED, the first phosphor and the second phosphor combine to form emitted light, the method comprising:
varying the electrical power to the LED light source causing at least one of flux of the LED light source to vary or the temperature of the lighting system to vary; and
whereon the emitted light varies in color as the conversion efficiency varies based on at least one of the flux varying or the temperature varying.

23. The method of claim 22, wherein the emitted light is characterized by a CCT, and wherein decreasing the electric power causes the CCT to decrease.
